(19) United States
(12) Patent Application Publication
(10) Pub. No.: US 2026/0322704 A1
(43) Pub. Date: Oct. 15, 2026

(54) Dynamic Artificial Intelligence (AI) Functionality and AI Model User Equipment (UE) Capability Reporting

(71) Applicant: Apple Inc., Cupertino, CA (US)

(72) Inventors: Huaning Niu, San Jose, CA (US); Dawei Zhang, Saratoga, CA (US); Haitong Sun, Saratoga, CA (US); Oghenekome Oteri, San Diego, CA (US); Wei Zeng, Saratoga, CA (US); Weidong Yang, San Diego, CA (US)

(21) Appl. No.: 19/482,629

(22) PCT Filed: Apr. 30, 2024
(86) PCT No.: PCT/US2024/027016

§ 371 Date: Nov. 7, 2025

Related U.S. Application Data
(60) Provisional application No. 63/501,650, filed on May 11, 2023.

(51) Int. Cl. H04L 41/16; H04W 24/10; H04W 76/27

(52) U.S. Cl. CPC H04L 41/16; H04W 24/10; H04W 76/27

(57) ABSTRACT

This application relates to an improved method of operating a user equipment (UE), comprising: receiving, at the UE, a first capability inquiry from a base station, relating to a capability of the UE to perform at least one task using a first model based on artificial intelligence (AI) or machine learning (ML); transmitting, to the base station, a response to the first capability inquiry, indicating UE whether the UE can perform the at least one task; receiving, at the UE, an indication of a particular AI or ML feature; evaluating, by the UE, whether the first mod-gNodeB el supports the particular AI or ML feature (e.g., based on a current UE position for a site-specific model, UE measurement for a scenario-specific model, and/or assistance information for a configuration-specific model); and transmitting, from the UE to the base station, an indication of whether the first model supports the particular AI or ML feature.

### TECHNICAL FIELD

The present application relates to wireless devices and wireless networks, including user devices, terminals, circuits, computer-readable media, and methods for performing dynamic artificial intelligence (AI)-based functionality and AI model User Equipment (UE) capability reporting.

### BACKGROUND

Wireless communication systems are rapidly growing in usage. In recent years, wireless devices such as smart phones and tablet computers have become increasingly sophisticated. In addition to supporting telephone calls, many mobile devices now provide access to the Internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), Long-Term Evolution (LTE), LTE Advanced (LTE-A), HSPA, 3GPP2 CDMA2000 (e.g., 1xRTT, 1xEV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies and beyond. Accordingly, improvements in the field in support of such development and design are desired.

Increasing interest is developing in the use of artificial intelligence (AI) and machine learning (ML)-based algorithms and tools. It may be possible to utilize such tools in any of a variety of possible areas of wireless communication. Some such areas may include: channel state information (CSI) feedback, beam measurement, and/or direct AI positioning, wherein feedback from a UE or base station (BS) may be used over time to train AI models and/or encoder/decoder pairs (e.g., UE/BS pairs) to improve link budget and/or other wireless communication system characteristics.

It has been agreed in 3GPP RAN1 that, for AI/ML-based functionality identification, the legacy 3GPP framework of features will be a starting point for discussion. For example, a UE shall be able to indicate supported functionalities for a given use case, and AI/ML-based models may be identified by “model IDs” at the network. Once a UE has indicated its supported AI/ML-based models, the network may perform life cycle management (LCM) of the various models, e.g., by indicating the activation, deactivation, fallback, switching, etc. of particular AI/ML-based functionality (or of particular AI/ML-based models, as identified by their respective model IDs) via existing 3GPP signaling (e.g., RRC, MAC CE, DCI).

However, for functionality-based (as well as for model ID-based) LCM of AI/ML-based models, there is a need to address additional conditions (e.g., specific scenarios, sites, and/or datasets) to ensure that a UE is using an appropriate model for the conditions that it is currently facing. For example, a particular model may be trained for specific UE configurations associated with an AI/ML-enabled feature(s) and additional conditions (e.g., specific scenarios, sites, and/or datasets) as determined/identified between the UE-side and NW-side. When a particular UE-side AI/ML-based model no longer supports a particular AI or ML feature, e.g., based on a current scenario/condition, it should not be used by the UE for performing the particular AI or ML feature for any longer. Instead, the model should be deactivated and/or switched to a model that is capable of handling the particular AI or ML feature based on the current scenario/conditions.

Thus, improvements have been proposed herein to provide techniques for dynamic AI functionality and AI model UE capability reporting in wireless systems.

### SUMMARY

In accordance with one or more embodiments, a method of operating a user equipment (UE) is disclosed herein, the method comprising: receiving, at the UE, a first capability inquiry from a base station, wherein the first capability inquiry relates to a capability of the UE to perform at least one task using a first model based on artificial intelligence (AI) or machine learning (ML); transmitting, from the UE to the base station, a response to the first capability inquiry, wherein the response indicates whether the UE can perform the at least one task; receiving, at the UE, an indication of a particular AI or ML feature; evaluating, by the UE, whether the first model supports the particular AI or ML feature; and transmitting, from the UE to the base station, an indication of whether the first model supports the particular AI or ML feature.

According to some aspects, the at least one task comprises one or more of: a channel state information (CSI)-related task; a beam management (BM)-related task; or a positioning-related task.

According to some aspects, a first task of the at least one task comprises a CSI compression task. According to some such aspects, the first model comprises a two-sided AI or ML model, wherein a first side of the two-sided AI or ML model is implemented at the UE, and wherein a second side of the two-sided AI or ML model is implemented at the base station. According to some such aspects, the indication of a particular AI or ML feature is received via an RRCConnectionReconfiguration message. According to some such aspects, the RRCConnectionReconfiguration message comprises at least one of: a dataset identifier, a model identifier for the second side of the first model, or assistance information, e.g., for data collection and inferencing.

According to some such aspects, the evaluating, by the UE, whether the first model supports the particular AI or ML feature comprises at least one of: evaluating whether the first side of the first model has been trained with a dataset identifier included in the RRCConnectionReconfiguration message; evaluating whether the first side of the first model has been trained with a model identifier for the second side of the first model included in the RRCConnectionReconfiguration message; or evaluating whether the first side of the first model has been trained with a dataset identifier included in UE Assistance Information (UAI) received in the RRCConnectionReconfiguration message.

According to other aspects, the indication of a particular AI or ML feature is received via an RRCConnectionReconfiguration message. According to some such aspects, the RRCConnectionReconfiguration message comprises assistance information, e.g., for categorizing a training data set.

According to other aspects, the indication of whether the first model supports the particular AI or ML feature is transmitted via an RRCReconfigurationComplete message.

According to still other aspects, the evaluating, by the UE, of whether the first model supports the particular AI or ML feature further comprises at least one of the following: evaluating, by the UE, whether a current position of the UE supports the particular AI or ML feature; evaluating, by the UE, whether a current measurement made at the UE supports the particular AI or ML feature; or evaluating, by the UE, whether a current value of assistance information supports the particular AI or ML feature.

According to other aspects, the transmitting, from the UE to the base station, of an indication of whether the first model supports the particular AI or ML feature further comprises transmitting an indication of at least one AI or ML feature that the first model does not support.

According to other aspects, the method further comprises: receiving, at the UE, an activation command from the base station, wherein the activation command indicates to the UE to activate the first model with the particular AI or ML feature. According to some such aspects, the activation command is received via one of: Downlink Control Information (DCI), Radio Resource Configuration (RRC), or Medium Access Control Control Element (MAC CE).

According to other such aspects, the method further comprises: transmitting, from the UE to the base station, an indication of a desire to deactivate the first model; and deactivating, at the UE, use of the first model. According to some such aspects, the indication of the desire to deactivate the first model is transmitted via UAI.

According to still other aspects, the at least one task comprises a beam management (BM)-related task, wherein the indication of the particular AI or ML feature is received via an RRCConnectionReconfiguration message, and wherein the RRCConnectionReconfiguration message includes a spatial domain beam prediction message. According to some such aspects, the spatial domain beam prediction message comprises: a Set A and Set B mapping pattern.

According to yet other aspects, the at least one task comprises a positioning-related task, wherein the indication of the particular AI or ML feature is received via an RRCConnectionReconfiguration message, and wherein the RRCConnectionReconfiguration message includes site-specific scenario information.

In accordance with one or more other embodiments, a method of operating a user equipment (UE) is disclosed herein, the method comprising: detecting, at the UE, a validity criterion failure for a first model configured to perform at least one positioning task based on artificial intelligence (AI) or machine learning (ML); transmitting, from the UE to a base station, a request to initiate a Random Access Channel (RACH) procedure; receiving, at the UE, a Random Access Response (RAR) message from the base station; transmitting, from the UE to a base station, an RRC Resume Request, wherein the RRC Resume Request contains a request for an update to the first model; and receiving, at the UE, an RRC Release message from the base station, wherein the RRC Release message contains updated configuration information for the first model.

According to some such aspects, the UE is in an RRC_INACTIVE mode or RRC IDLE mode when the validity criterion failure is detected.

According to other such aspects, the detection of the validity criterion failure occurs in response to one of: a periodic validity criterion checking operation; or an event-based validity criterion checking operation.

According to still other such aspects, the RAR message comprises UAI.

According to yet other such aspects, the request to initiate a RACH procedure and the RRC Resume Request are transmitted to the base station in a single message. According to some such aspects, the RAR message and the RRC Release message may also be received from the base station in a single message.

According to other aspects, the method may further comprise: entering, at the UE, into an RRC_CONNECTED mode after receiving the updated configuration information for the first model, wherein additional updated configuration information is transmitted via an RRC_Resume_Complete message.

The various methods and techniques summarized in this section may likewise be performed by a UE device comprising: a receiver; a transmitter; and a processor configured to perform any of the various methods and techniques summarized herein. The various methods and techniques summarized in this section may likewise be stored as instructions in a non-volatile computer-readable medium, wherein the instructions, when executed, cause the performance of the various methods and techniques summarized herein.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates another example of a wireless communication system, according to some aspects.

FIG. 3 illustrates an example block diagram of a UE, according to some aspects.

FIG. 4 illustrates an example block diagram of a Base Station (BS), according to some aspects.

FIG. 5 illustrates a flow diagram detailing a method of performing dynamic AI model UE capability reporting, according to some aspects.

FIG. 6 illustrates a flow diagram detailing a method of performing dynamic UE capability reporting related to using a two-sided channel state information (CSI) compression model, according to some aspects.

FIG. 7 illustrates a flow diagram detailing a method of performing dynamic UE capability reporting related to a beam management task, such as spatial domain beam prediction and/or time domain beam prediction, according to some aspects.

FIG. 8 illustrates a flow diagram detailing a method of performing dynamic UE capability reporting related to a direct AI positioning and/or assisted AI positioning task, according to some aspects.

FIG. 9A illustrates a flow diagram detailing a method of using a four-step Random Access Channel (RACH) procedure to dynamically update an AI/ML model at a UE in an RRC_INACTIVE or RRC_IDLE state, according to some aspects.

FIG. 9B illustrates a flow diagram detailing a method of using a two-step RACH procedure to dynamically update an AI/ML model at a UE in an RRC_INACTIVE or RRC_IDLE state, according to some aspects.

FIG. 9C illustrates a flow diagram detailing a method of reactive and proactive reporting of applicable UE AI/ML functionalities, according to some aspects.

FIG. 10A is a flowchart detailing a method of performing dynamic AI model UE capability reporting, according to some aspects.

FIG. 10B is a flowchart detailing a method of using a RACH procedure to dynamically update an AI/ML model at a UE in an RRC_INACTIVE or RRC_IDLE state, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

The present application relates to improved methods for performing dynamic AI functionality and AI model UE capability reporting in wireless systems.

As mentioned above, it has been agreed in 3GPP to use legacy UE capability reporting to report AI-related functionality. While some AI-related parameters are similar to normal UE features, having static configurations that can be reported via legacy UE capability reporting as a response to a UE capability inquiry, there are other aspects of AI/ML-based models that are different compared to traditional UE features.

For example, some AI/ML-based models are trained to be “scenario specific,” i.e., such models are trained to only perform well in certain scenario, such as indoors. Other AI/ML-based models may be “configuration-specific,” e.g., using only certain Set A and Set B mapping in beam management (BM) tasks. Still other AI/ML-based models may be “site-specific,” e.g., AI models for determining positioning may only be trained for a certain indoor factory. As such, the legacy UE capability inquiry/response functionality cannot handle these dynamic scenarios.

In this disclosure, various methods of dynamically reporting AI/ML-based model functionality, e.g., using the RRCResumeComplete and/or RRCReconfigurationComplete messages, are described. While the various methods and techniques described in this disclosure may be applied to a general framework for model updating, they are described here predominantly in the context of the currently contemplated Release-18 use cases and future 3GPP AI use case, such as CSI compression, beam management, and direct AI-based UE positioning determination.

The following is a glossary of additional terms that may be used in this disclosure:
Memory Medium—Any of various types of non-transitory memory devices or storage devices. The term “memory medium” is intended to include an installation medium, (e.g., a CD-ROM, floppy disks, or tape device; a computer system memory or random-access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”
User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™, Nintendo DS™, Play Station Vita™, Play Station Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.
Wireless Device—any of various types of computer systems or devices that perform wireless communications. A wireless device may be portable (or mobile) or may be stationary or fixed at a certain location. A UE is an example of a wireless device.
Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.
Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.
Node—The term “node,” or “wireless node” as used herein, may refer to one more apparatus associated with a cell that provide a wireless connection between user devices and a wired network generally.
Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.
Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).
Band—The term “band” has the full breadth of its ordinary meaning, and at least includes a section of spectrum (e.g., radio frequency spectrum) in which channels are used or set aside for the same purpose.
Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

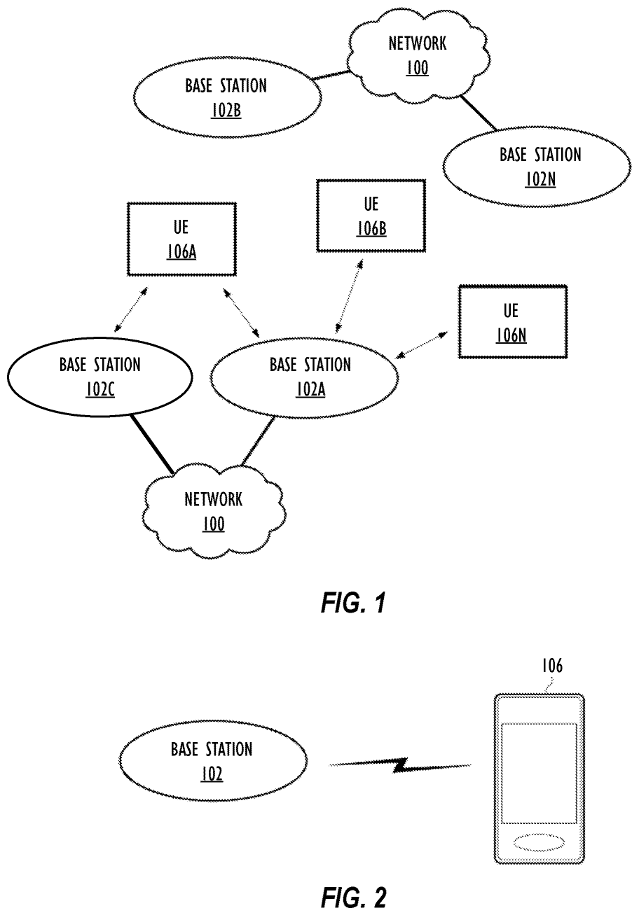

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106N. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using an SL interface for direct communications between devices. The IoT UEs may also execute background applications (e.g., keep-alive messages, status updates, and the like) to facilitate the connections of the IoT network.

As shown, the UEs 106, such as UE 106A and UE 106B, may directly exchange communication data via an SL interface 108. The SL interface 108 may be a PC5 interface comprising one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (vUEs). The RSU may also include internal data storage circuitry to store intersection map geometry, traffic statistics, media, as well as applications/software to sense and control ongoing vehicular and pedestrian traffic. The RSU may operate on the 5.9 GHz Intelligent Transport Systems (ITS) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weather enclosure suitable for outdoor installation, and it may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106N and similar devices over a geographic area via one or more cellular communication standards.

Thus, while base station 102A may act as a “serving cell” for UEs 106A-106N as illustrated in FIG. 1, each UE 106 may also be capable of receiving signals from (and possibly within communication range of) one or more other cells (which may be provided by base stations 102B-102N and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102N may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106a.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

As illustrated in FIG. 2, in one or more embodiments, the UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1xRTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource selection. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Example Communication Device

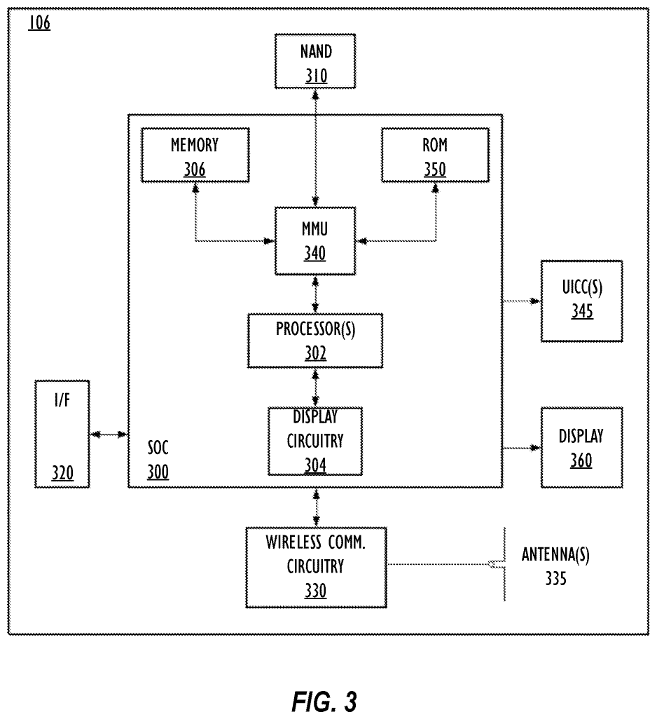

FIG. 3 illustrates an example simplified block diagram of a communication device 106, according to some aspects. It is noted that the block diagram of the communication device of FIG. 3 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components configured to perform core functions. For example, this set of components may be implemented as a system on chip (SOC), which may include portions for various purposes. Alternatively, this set of components may be implemented as separate components or groups of components for the various purposes. The set of components 200 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; and the like), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 330 may couple (e.g., communicatively; directly or indirectly) to one or more antennas, such as antenna(s) 335 (each of which may include an antenna panel), as shown. The wireless communication circuitry 230 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 330 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mm Wave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements.

The communication device 106 may further include one or more smart cards 345 that include Subscriber Identity Module (SIM) functionality, such as one or more Universal Integrated Circuit Card(s) (UICC(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein (e.g., by executing program instructions stored on a memory medium). Alternatively (or in addition), processor 302 may be configured as a programmable hardware element, such as a Field Programmable Gate Array (FPGA), or as an Application Specific Integrated Circuit (ASIC). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, and the like) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, and the like) configured to perform the functions of wireless communication circuitry 330.

### Example Base Station

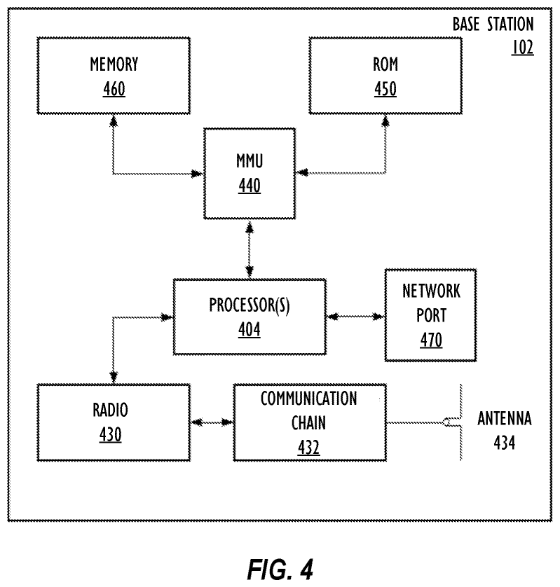

FIG. 4 illustrates an example block diagram of a base station 102, according to some aspects. It is noted that the base station of FIG. 4 is a non-limiting example of a possible base station. As shown, the base station 102 may include processor(s) 304 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIG. 1.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, (e.g., a 5G New Radio (5G NR) base station, or “gNB”). In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas or antenna panels. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including 5G NR, LTE, LTE-A, GSM, UMTS, CDMA2000, Wi-Fi, and the like.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mm Wave, the 5G NR radio may be coupled to one or more mm Wave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 102 may include hardware and software components for implementing or supporting implementation of features described herein. The processor 404 of the base station 102 may be configured to implement or support implementation of part or all of the methods described herein (e.g., by executing program instructions stored on a memory medium). Alternatively, the processor 404 may be configured as a programmable hardware element, such as a Field Programmable Gate Array (FPGA), or as an Application Specific Integrated Circuit (ASIC), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, and the like) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, and the like) configured to perform the functions of radio 430.

### Dynamic AI Functionality and AI Model UE Capability Reporting

As used herein, Artificial intelligence (AI) refers to the simulation of human intelligence processes by machines, usually computer systems, and Machine learning (ML) refers to a subset of AI that creates algorithms and statistical models to perform a specific task without using explicit instructions, relying instead on patterns and inference. ML algorithms may build mathematical models based on sample data, called training data, to make predictions or decisions without being programmed specifically for that task. Learned signal processing algorithms are expected to empower the next generation of wireless systems with significant reductions in power consumption and improvements in density, throughput, and accuracy when compared to the brittle and manually-designed systems of today.

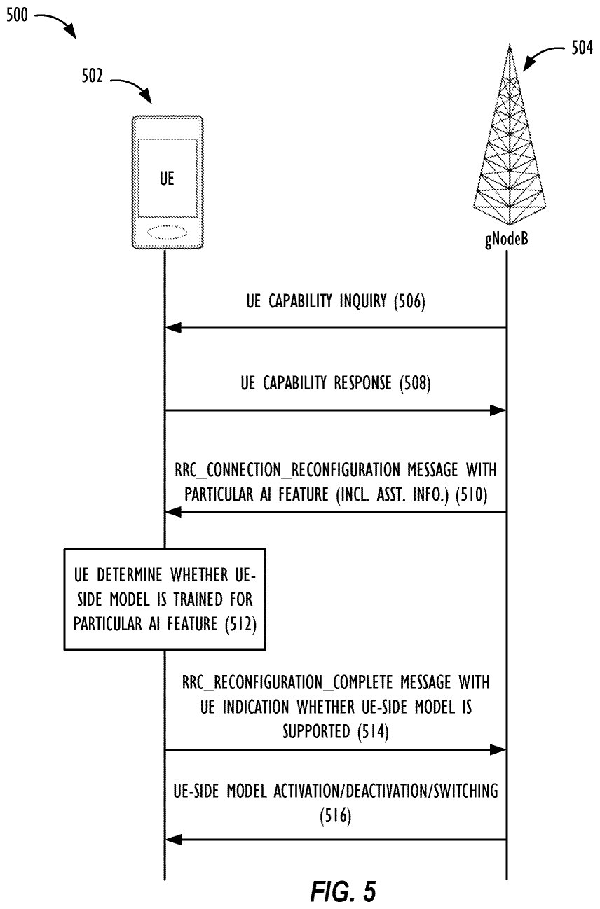

FIG. 5 illustrates a flow diagram detailing a method 500 of performing dynamic AI model UE capability reporting, according to some aspects. Method 500 provides a general procedure that may be followed for dynamic AI/ML-based model updating for UEs in an RRC_CONNECTED mode.

Method 500 may begin by a UE 502 and a network base station, e.g., gNodeB/gNB 504, performing a legacy UE capability operation, wherein the gNB 504 sends a UE capability inquiry (506), and the UE 502 responds with a UE capability response (508). However, as outlined above, this legacy UE capability procedure may not be sufficient to handle certain types of information, e.g., AI/ML-based models that are scenario-specific, configuration-specific, and/or site-specific.

Thus, according to the general procedure shown in method 500, gNB 504 may transmit an RRCconnectionReconfiguration to UE 502 with an indication of a corresponding particular AI or ML feature. If assistance information is used in the categorizing of the measurement(s) for data collection for the particular AI/ML-based model, the assistance information may likewise be part of the RRCConnectionReconfiguration message.

Next, at 512, the UE 502 may evaluate whether the UE-side model will work with the particular AI/ML-based feature (e.g., based on the UE's current position for a site-specific model, based on a current UE measurement for a scenario-specific model, and/or based on the assistance information for a configuration-specific model).

At 514, the UE 502 may send UE capability information, indicating whether the particular AI/ML-based feature is supported by the current site/scenario/configuration of the UE-side model or the UE-part of a two-sided model. According to some aspects, this indication of support may be transmitted as part of an RRCReconfigurationComplete message. In addition to a UE indicating whether the current configuration is supported or not, according to some aspects, a UE may also indicate which configuration(s) are not supported. According to these aspects, the UE 502 does not need to disclose any proprietary implementation-related information, or any privacy-related information to the network. Instead, the UE only needs to indicate the AI/ML-based model's capability to support the current AI/ML feature.

### Example 1: CSI Compression Model

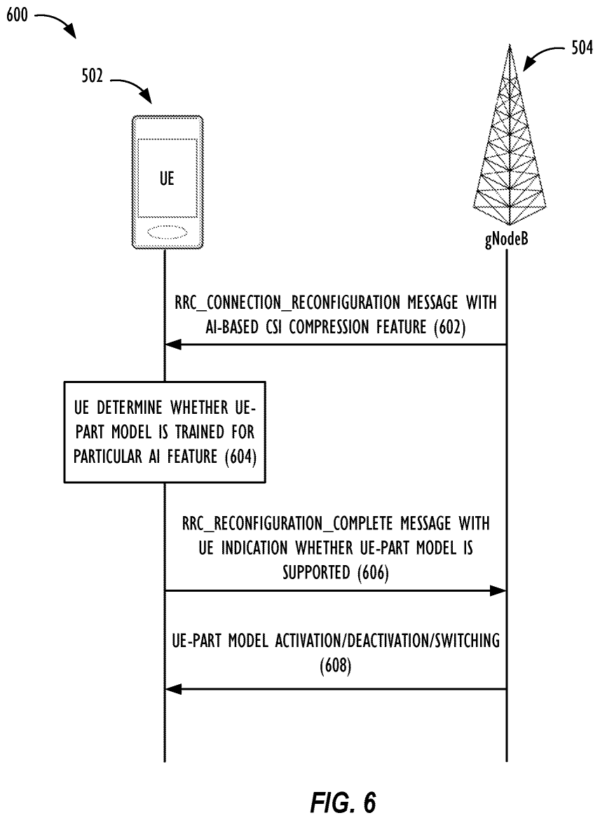

Turning now to FIG. 6, a flow diagram detailing a method 600 of performing dynamic UE capability reporting related to using a two-sided channel state information (CSI) compression model is illustrated, according to some aspects. CSI compression is an example of a task that may be performed using a two-sided AI/ML model. For example, an encoder portion of the model may be implemented at the UE-part, and a decoder portion of the model may be implemented at the Network-part.

While encoder-decoder pairs may be sufficiently well-specified and efficient given sufficient training samples and associated models, it may also be beneficial to allow independent evolution (e.g., updating) of both the encoder and decoder models over time and as operating environments may change. More specifically, an encoder implemented at a UE may utilize uplink compression techniques when providing information (e.g., training samples) for machine learning models, while a base station may perform decoding or decompression of said training samples, so as to be able to identify or select a compatible machine learning model for communication.

For example, there may be wireless communication scenarios in which a mobile device may need to send a summary of its observations to one or more entities such as a base station (e.g., a gNB), a network side server and/or a UE side server. Moreover, some examples of said observations may include channel state feedback and/or beam measurement feedback. Furthermore, it may be desirable to minimize the number of bits required to send the observations in order to reduce transmit power, extend battery life, and minimize network and over-the-air uplink resource consumption.

In some embodiments, one approach may be to compress the observations (or associated signaling) to minimize the number of bits required to transmit them. Compression techniques typically require a compressor (e.g., encoder) and matching decompressor (e.g., decoder). According to some scenarios, the encoder should typically be tuned to the statistical characteristics of the observations and acceptable distortion levels. These characteristics may be a function of the device itself (including software version), its operating environment (channel characteristics), the network configuration, among various other factors. In other words, it may be beneficial for an encoder (e.g., a wireless device) to perform occasional or scheduled measurements of its operating environment in order to be aware of the state of the channel in regards to how efficient its wireless communications may be.

Accordingly, when reporting its measurements, it may be further desirable to minimize the number of bits needed to transmit this information. Therefore, before transmission, the encoder may benefit from compressing the measurements or measurement results (e.g., into a reduced number of bits) in order to achieve reduced transmit power (thereby potentially extending battery life) and minimizing uplink resource consumption. Similarly, a decoder in communication with the encoder may also benefit from the reduced number of bits (e.g., compression) of the measurements since decompression of a smaller number of bits may require less processing power.

Further, it may be desirable to allow the network and device software to evolve, update, or change at their own schedules and choose any implementation of encoder and decoder-as long as the two remain compatible. The network may have additional considerations, such as implementing a single decoder that is compatible with the encoders of various device types from different device manufacturers. Further, both device and network vendors may prefer to accomplish the development of encoders and decoders while preserving user privacy (e.g., identity, location, operating environment) and minimizing the revelation of proprietary information on device or network capabilities and configuration.

According to some embodiments, an encoder-decoder pair may be associated with a model ID. Moreover, the model ID be further be associated or include observation statistics as well as fields of compatibility (e.g., NW vendor identification, UE vendor identification, etc.). Accordingly, the fields corresponding to compatibility may determine whether or not the model ID can be used for communication between the encoder (e.g., compressor) and decoder (e.g., decompressor). Accordingly, it may be beneficial for to develop model identifiers (IDs) for an encoder and decoder using model learning techniques while maintaining compatibility.

For example, by associating a model ID with a collection of observation statistics (e.g., channel characteristics, hardware (HW) or software (SW) versions, network configurations, etc.), when the encoder/decoder pair (e.g., UE/BS pair, as one example) is operating under different conditions (e.g., operating under different channel characteristics, different HW/SW versions, etc.), a different model ID may be appropriately selected for more efficient communications corresponding to the pair's current operating conditions, according to some embodiments. Moreover, by updating the observation statistics associated with model IDs, the models can also be effectively updated through the association of the model to the model ID. In other words, updated models used by the encoder/decoder pair would reflect or include updated observation statistics (e.g., channel characteristics, HW/SW versions, etc.) through association of the model ID to the model. Accordingly, more efficient communications between the pair may be realized through continuous or semi-persistent training of the models based on observed conditions and subsequent selection of a compatible and most efficient model ID.

According to other embodiments, an encoder-decoder pair may be associated with a dataset ID, and so-called “Type 3” training collaboration is used, i.e., separate training of the model at the network-side and UE-side, where the UE-side CSI generation part and the network-side CSI reconstruction part are trained by UE-side and network-side, respectively. With Type 3 training collaboration, a model may either be trained at the network-side first or the UE-side first.

Returning now to FIG. 6, according to some aspects, at 602, gNB 504 may transmit a RRCconnectionReconfiguration message including AI-based CSI compression-related configuration. For example, the configuration can include the dataset ID if training collaboration Type 3 was used to train the two-sided model. Alternatively, the configuration information can include the network-side model ID if it was trained by offline training Type 2 (i.e., joint training of the two-sided model at network-side and UE-side, respectively) or training Type 3. Finally, the configuration can also include the assistance information if it was included in UE-side data collection, e.g., where certain information regarding antenna configuration virtualization, size, panel, etc., may be indicated.

Next, at 604, UE 502 may determine whether the UE-side model is supported in this cell. For example, the UE may evaluate whether the encoder is trained with the dataset ID in training Type 3 network-first training, or, if the encoder is offline-trained to work with the particular network-side model ID, and/or if the encoder is trained with the dataset that matches the assistance information configuration.

Next, at 606, UE 502 may indicate, e.g., via a RRCReconfigurationComplete message, whether the UE-part of the model (e.g., the encoder) will work in the current scenario/conditions. If the UE indicates its support for this particular AI-based CSI compression feature, then, at 608, the gNB 504 may subsequently activate/deactivate/switch, etc., the AI-based CSI compression function, e.g., by RRC, MAC CE, Downlink Control Information (DCI), or any other desired signaling method.

### Example 2: Beam Management Tasks

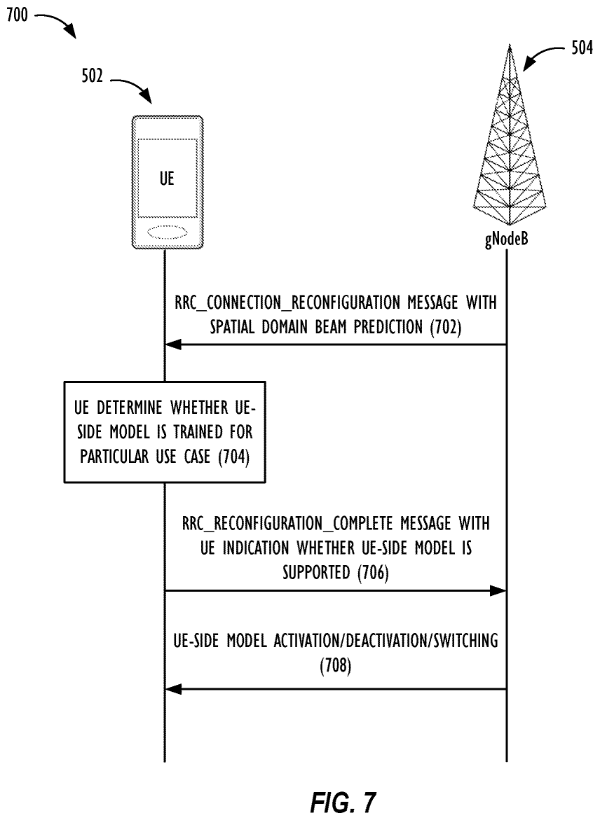

Turning now to FIG. 7, a flow diagram detailing a method 700 of performing dynamic UE capability reporting related to a beam management task (e.g., spatial domain beam prediction and/or time domain beam prediction) is illustrated, according to some aspects.

Beam measurement techniques used for beamforming are widely-used in wireless communication systems, typically as a technique to improve the link budget. The beamforming may be implemented in both a cellular base station (e.g., gNB, eNB, etc.) and a wireless device (e.g., a UE), for example in a cellular communication system. A good beam pair can help increase the system performance, at least in some instances.

For a BS-UE beam pair, it may be the case that the BS transmits multiple downlink reference signals, where different BS beams may be applied to different reference signals, for the UE to measure the quality for each beam. The UE can further use different receive beams to receive different instances of one reference signal, e.g., to identify the best UE beam for each BS beam. The downlink reference signals provided by the BS could include synchronization signal blocks (SSBs), or channel state information reference signals (CSI-RS), in some embodiments. Thus, to identify the BS-UE beam pair, it may be the case that a UE needs to perform measurement for several BS beams with UE beam sweeping operation.

However, it may be possible to use machine learning techniques to avoid the need for a UE to perform such extensive beam measurements. Such machine learning techniques may, for example, be used to help to identify the best BS beam without directly measuring BS beams, so that the UE can identify a UE beam to accommodate this best BS beam, potentially more quickly and/or with less overhead than otherwise might be possible.

Aspects of such machine learning techniques could be implemented on the BS side, in one possible scheme. Alternatively, the machine learning could be implemented on the UE side, in another possible scheme. As further possibilities, the machine learning could be implemented partially by each of the BS and UE sides. For example, in one scheme, training (e.g., machine learning) could be implemented on the BS side, while inference (i.e., use of the trained model) is implemented on the UE side. In another scheme, training could be implemented on the UE side, while inference is implemented on the BS side. The inference may be based on metadata or operating conditions associated with a model ID. It may be possible that the choice of which scheme is used can be configured by the BS, potentially based, at least in part, on the capability of the UE to support one or more such schemes, e.g., as may be indicated by the UE in capability information provided by the UE to the BS.

In order to support use of such techniques, it may be important to provide a framework according to which a wireless device and a cellular network can exchange information to determine whether such techniques are mutually supported and potentially to negotiate or agree upon the characteristics and parameters according to which AI/ML-based model maintenance is performed, and/or to exchange information for supporting the operation of the AI/ML-based model in performing cellular communication, as well as to provide techniques for the use of machine learning in performing cellular communication.

Returning now to FIG. 7, according to some aspects, at 702, gNB 504 may transmit an RRCconnectionReconfiguration message including a spatial domain beam prediction message to a UE 502 that is in an RRC_CONNECTED mode. According to some aspects, Set A and Set B mapping information may be included in the configuration. (Set A refers to a prediction beam set, and Set B refers a measurement beam set.)

At 704, the UE 502 may evaluate whether the UE-side AI model work is trained for the particular use case. For example, if the UE-side model supports this particular Set A and Set B mapping pattern, then the UE may determine that the UE-side AI model will work in this use case. As another example, the network may configure the BM-based feature (or one or more feature groups under the BM-based feature) for the UE, and the UE may report whether such a BM feature—or whether any, some, or all of the feature groups are supported. (It is noted that, some BM use cases can utilize functionality-based LCM. In such cases, no model or model ID is visible to the air interface.)

Next, at 706, the UE 502 may transmit a UE capability indication of whether the UE-side model is capable or not. According to some aspects, this indication may be transmitted as part of an RRCReconfigurationComplete message. Finally, if the UE indicates its support for this particular BM-based feature, then, at 708, the gNB 504 may subsequently activate/deactivate/switch, etc., the AI-based BM function, e.g., by RRC, MAC CE, DCI, or any other desired signaling method.

### Example 3: AI-Based Positioning Tasks

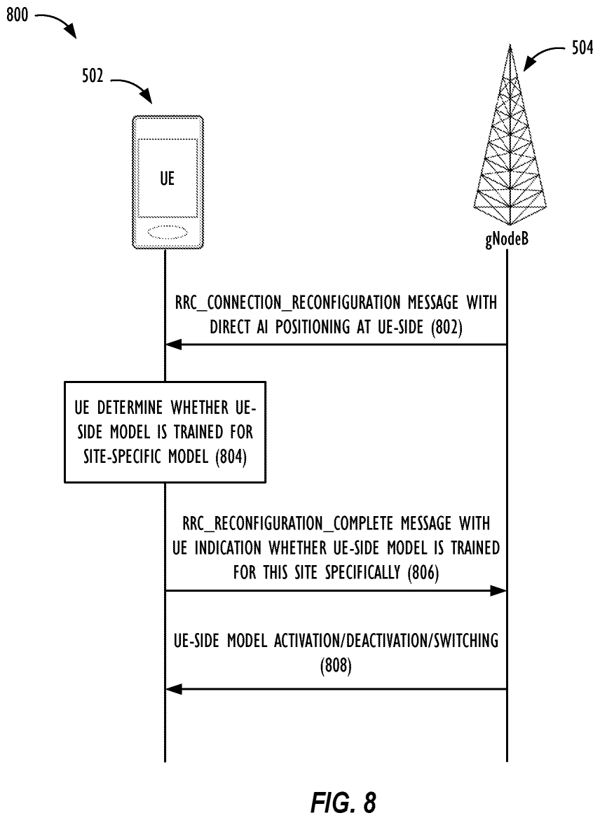

Turning now to FIG. 8, a flow diagram detailing a method 800 of performing dynamic UE capability reporting related to a direct AI positioning and/or assisted AI positioning task is illustrated, according to some aspects. At 802, gNB 504 may transmit an RRCconnectionReconfiguration message including direct AI positioning information to a UE 502 that is in an RRC CONNECTED mode. According to some aspects, assistance information, such as scenario-specific information and/or scenario change information may also be sent to the UE 502 as part of the RRCconnectionReconfiguration message (e.g., gNB 504 can signal a number of TRPs or any TRP changes, such as TRPs that have been switched ON/OFF or that have had different TRP configuration changes).

Next, at 804, the UE 502 may evaluate whether the UE-side AI model will work in this site-specific model. For example, according to some aspects, a UE can determine the site information based on its GPS information, and then evaluate whether the AI model will work at the UE's current GPS location. (It is noted that, some AI positioning use cases can utilize functionality-based LCM. In such cases, no model or model ID is visible to the air interface.)

Next, at 806, the UE 502 may transmit a UE capability indication of whether the UE-side model is capable or not. According to some aspects, this indication may be transmitted as part of an RRCReconfigurationComplete message. Finally, if the UE indicates its support for this particular AI-based positioning feature, then, at 808, the gNB 504 may subsequently activate/deactivate/switch, etc., the AI-based positioning function, e.g., by RRC, MAC CE, DCI, or any other desired signaling method.

### Example 4: AI-Based Positioning for UEs in RRC_INACTIVE or RRC_IDLE Modes

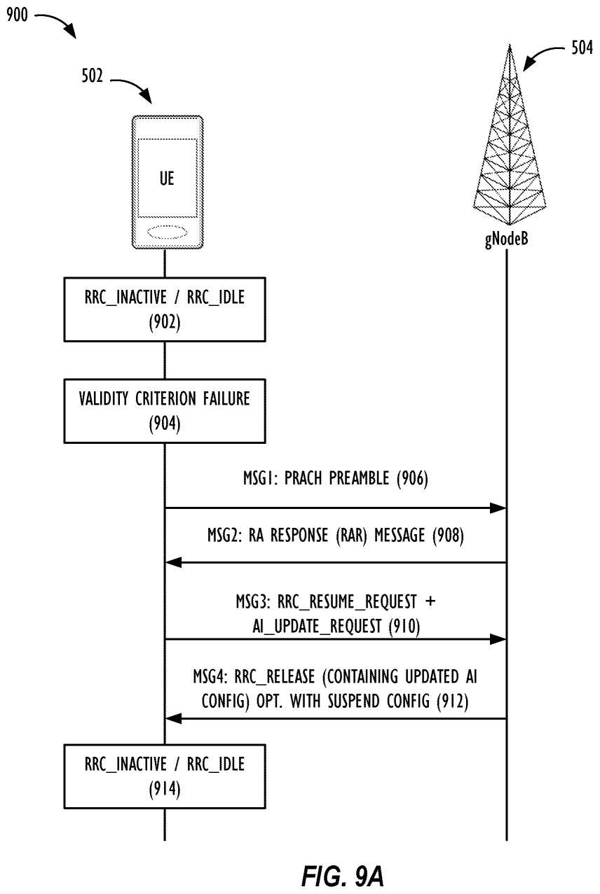

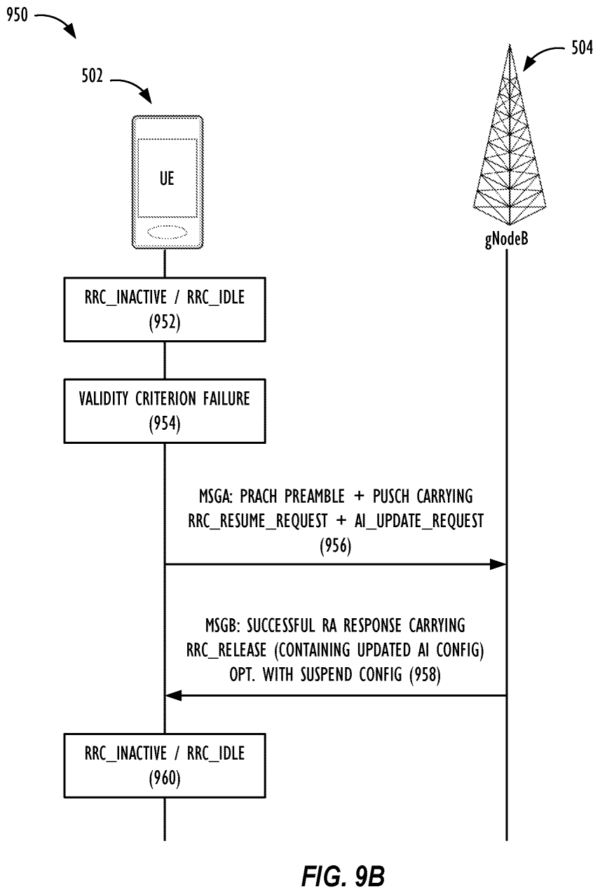

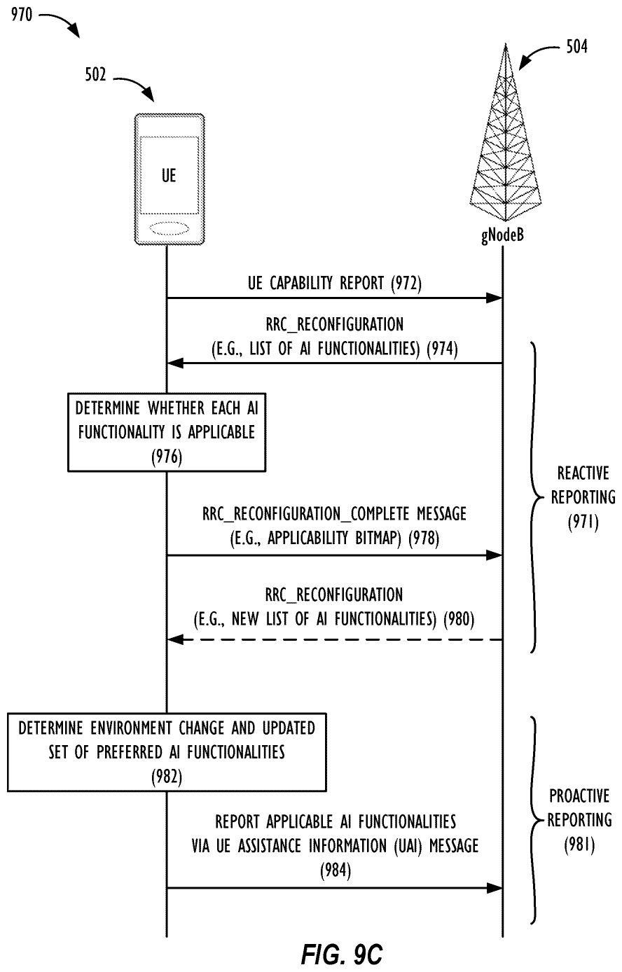

Turning now to FIG. 9A, a flow diagram detailing a method 900 of using a four-step Random Access Channel (RACH) procedure to dynamically update an AI/ML model at a UE in an RRC INACTIVE or RRC_IDLE state is illustrated, according to some aspects. The examples of FIGS. 9A and 9B will be described in the context of an AI-based positioning model because, among the three exemplary model types described herein (and contemplated in Release-18), AI-based positioning is the only model where inferencing may be performed by a UE in an RRC_INACTIVE or RRC_IDLE mode (i.e., CSI compression and BM-based models both only operate when a UE is in RRC_CONNECTED modes.) (It is noted that, some AI positioning use cases can utilize functionality-based LCM. In such cases, no model or model ID is visible to the air interface.)

Starting at 902, a UE 502 is in an RRC INACTIVE or RRC_IDLE mode. At 904, the UE 502 may determine that a model has failed one or more of its validity criterion, i.e., the model is no longer suitable for its intended purpose. According to one aspect, the detection of the validity criterion failure occurs in response to an event-based validity criterion checking operation. For example, an AI/ML-based positioning validity criterion may defined, and, if/when the validity criterion fails, the UE may perform the RACH procedure (e.g., as illustrated in exemplary FIG. 9A and FIG. 9B). Causes of validity criterion failure may include, e.g., tracking area (TA) failure, the UE moving outside its cell/cell-group area, etc. According to another aspect, the detection of the validity criterion failure may instead occur in response to a periodic validity criterion checking operation, i.e., the UE may perform RACH at some pre-configured interval to update its AI model configuration.

The RACH process may begin at 906, with the transmission of a Msg1 (i.e., PRACH preamble) from the UE 502 to the gNB 504. Next, at 908, the Msg2 (i.e., Random Access Response or RAR message) may be received at UE 502. According to some aspects, the assistance information may be part of the RAR message.

At 910, the Msg3 (i.e., RRC Resume Request) may be transmitted to gNB 504. According to some aspects, the Msg3 may further comprise the AI-model update request and/or a capability acknowledgement from the UE. In other words, the Msg3 may be used by the UE 502 as a convenient mechanism to indicate to the network its need for an updated AI-based positioning model.

At 912, the RRC_RELEASE message may be received at UE 502, including any updated AI-based configuration information. For example, the configuration information may be of measurement input types, or it may be of positioning reference signals (PRSs) for Transmission and Reception Points (TRPs) that are to be measured by the UE. Note, if the RRC RELEASE message at 912 is sent including suspend config, the UE 502 will enter an RRC_INACTIVE mode at 914; if, instead, the RRC_RELEASE message is sent without suspend config, the UE 502 will enter an RRC IDLE mode at 914.

Turning now to FIG. 9B, a flow diagram detailing a method 950 of using a two-step RACH procedure to dynamically update an AI/ML model at a UE in an RRC INACTIVE or RRC IDLE state is illustrated, according to some aspects. As will be appreciated, the substantive difference between FIG. 9A and FIG. 9B is that FIG. 9A uses the traditional 4-step RACH approach with four messages, while FIG. 9B uses a 2-step RACH approach, which combines the transmitted information into a single “Msg A” that is transmitted to the gNB, and a single “Msg B” that is transmitted back to the UE.

Thus, as described above with reference to FIG. 9A, method 950 may begin at 952 with a UE that is in an RRC INACTIVE or RRC IDLE mode. At 954, the UE 502 may again determine that a model has failed one or more of its validity criterion. Diverting now from method 900, at 956, according to method 950, the UE 502 may transmit a Msg A to the gNB 504, which includes the PRACH preamble, a PUSCH carrying the RRC Resume Request, as well as the AI-model update request.

In response, at 958, the gNB 504 may transmit a Msg B to the UE 502, which includes a successful RAR message and also carries the RRC_RELEASE message including any updated AI-based configuration information. As described above, if the Msg B at 958 is sent including suspend config, the UE 502 will enter an RRC_INACTIVE mode at 960; if, instead, the Msg B is sent without suspend config, the UE 502 will enter an RRC IDLE mode at 960.

According to still other aspects, the UE may enter an RRC_CONNECTED mode after the update (i.e., rather than returning to an RRC_INACTIVE or RRC_IDLE mode). In such cases, the RRC Resume message may be used to include any additional assistance information, and the configuration update may be transmitted as part to the RRCResumeComplete message.

### Dynamic Update Using UE Assistance Information (UAI)

According to some aspects, a UE may also want to dynamically and “proactively” activate or deactivate a UE-side model. For example, the UE may want to conserve power, and thus want to turn off certain AI model inferencing. As another example, due to changes in the UE's mobility or environmental changes, previously-supported AI models may no longer be able to be supported by the UE. Thus, according to some aspects, UE Assistance Information (UAI) may be used to indicate a UE's preference to activate and/or deactivate a particular AI or ML-based feature (e.g., either via reactive reporting or proactive reporting). According to some aspects, the UAI may be configured to indicate the exact AI functionality (or AI model) that the UE would like to deactivate.

For example, in some embodiments, the RRCConnectionReconfiguration message may include an otherConfig message. In otherConfig, for each AI functionality, if the otherConfig received by the UE includes a particular AI or ML-based feature, the UE will be configured to provide its preference on whether or not it wants to activate the particular AI or ML-based feature.

### Example of Combined Reactive and Proactive UE-Side AI/ML Functionality Reporting

Turning now to FIG. 9C, a flow diagram 970 detailing a method of reactive and proactive reporting of applicable UE AI/ML functionalities is illustrated, according to some aspects. First, method 970 may begin at 972 with a UE 502 providing a capability report to the network, e.g., to gNB 504. UE capability report 972 may comprise, e.g., a list of AI/ML features or feature groups supported by the UE.

According to a so-called “reactive reporting” scheme 971, the next step 974 in method 970 may be for the UE 502 to receive an RRCReconfiguration message, e.g., including a list of AI/ML functionalities that the gNB 504 would like to configure the UE 502 to use. Next, at 976, the UE may determine whether each of the configured AI/ML functionalities is applicable to the UE's current status. For example, some AI/ML functionalities may not work well in the UE's current environment and/or due to some restriction on the UE's internal status (e.g., high memory usage, low battery, etc.). In some such embodiments, at 978, the UE 502 may report back, e.g., via a bitmap transmitted in an RRCReconfiguraitonComplete message, an indication of whether each of the configured AI/ML functionalities are applicable to the UE in its current status and environment (e.g., a 1-bit indication of whether each configured AI/ML functionality is applicable or not). Finally, at 980, an optional additional RRCReconfiguration message could be transmitted form gNB 504 to UE 502, including a new or updated list of AI/ML features or models.

Alternatively, according to a so-called “proactive reporting” scheme 981, the next step 982 after step 972 in method 970 may be for UE 502 to determine any environmental changes, which may result in an updated set of preferred AI/ML functionality for the UE 502 to utilize. Then, at 984, the UE 502 may “proactively” report a listing of any applicable AI/ML functionalities, e.g., via a UE Assistance Information (UAI) message or LTE Positioning Protocol (LPP) message, directly to gNB 504. As may now be appreciated, proactive reporting can be used by the UE to feedback its applicable AI/ML functionalities without network configuration. According to some implementations, in order to all the UE to hide its internal status from the network, the UE doesn't need to explicitly report the changes it has experienced, but it may instead report only the updated AI/ML functionalities that are applicable.

According to still other implementations, the UE may use both reactive reporting and proactive reporting in different situations. In such implementations, the list of applicable AI/ML functionalities reported to the network at 984 (i.e., via proactive reporting) may not overlap with the list reported via RRCReconfiguraitonComplete at 978 (i.e., via reactive reporting).

### Exemplary Methods

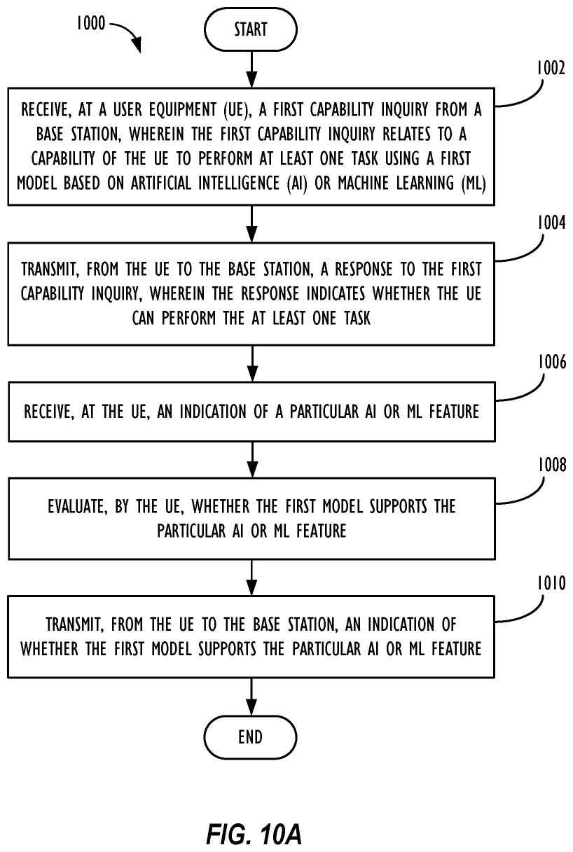

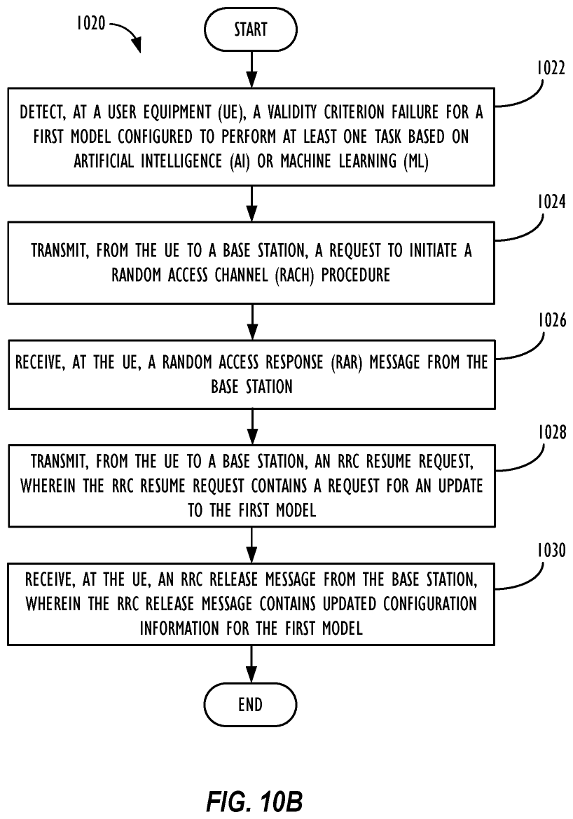

Turning now to FIG. 10A, a flowchart detailing a method 1000 of dynamic AI model UE capability reporting is illustrated, according to some aspects. First, at block 1002, a UE practicing the method of 1000 may receive, at a UE, a first capability inquiry from a base station, wherein the first capability inquiry relates to a capability of the UE to perform at least one task using a first model based on AI or ML. Next, at block 1004, the method 1000 may transmit, from the UE to the base station, a response to the first capability inquiry, wherein the response indicates whether the UE can perform the at least one task.

At block 1006, the UE may receive an indication of a particular AI or ML feature. At block 1008, the UE may evaluate whether the first model supports the particular AI or ML feature. Finally, at block 1010, the UE may transmit to the base station, an indication of whether the first model supports the particular AI or ML feature.

Turning now to FIG. 10B, a flowchart detailing a method 1020 of using a RACH procedure to dynamically update an AI/ML model at a UE in an RRC_INACTIVE or RRC_IDLE state is illustrated, according to some aspects. First, at block 1022, a UE may detect a validity criterion failure for a first model configured to perform at least one positioning task based on AI or ML. Next, at block 1024, the method 1020 may transmit, from the UE to a base station, a request to initiate a Random Access Channel (RACH) procedure.

At block 1026, the UE may receive a Random Access Response (RAR) message from the base station. At block 1028, the UE may transmit, to a base station, an RRC Resume Request, wherein the RRC Resume Request contains a request for an update to the first model. Finally, at block 1030, the UE may receive, from the base station, an RRC Release message, wherein the RRC Release message contains updated configuration information for the first model.

### Additional Comments

The use of the connective term “and/or” is meant to represent all possible alternatives of the conjunction “and” and the conjunction “or.” For example, the sentence “configuration of A and/or B” includes the meaning and of sentences “configuration of A and B” and “configuration of A or B.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

1. A method of operating a wireless device, the method comprising:
receiving a first capability inquiry from a base station, wherein the first capability inquiry relates to a capability of the UE to perform at least one task using a first model based on artificial intelligence (AI) or machine learning (ML);
transmitting, to the base station a response to the first capability inquiry, wherein the response indicates whether the UE can perform the at least one task;
receiving an indication of a particular AI or ML feature;
evaluating, by the UE, whether the first model supports the particular AI or ML feature; and
transmitting, to the base station an indication of whether the first model supports the particular AI or ML feature.

2. (canceled)

3. The method of claim 1, wherein a first task of the at least one task comprises a CSI compression task.

4. The method of claim 3, wherein the first model comprises a two-sided AI or ML model, wherein a first side of the two-sided AI or ML model is implemented at the wireless device, and wherein a second side of the two-sided AI or ML model is implemented at the base station.

5. The method of claim 4, wherein the indication of a particular AI or ML feature is received via an RRCConnectionReconfiguration message.

6. The method of claim 5, wherein the RRCConnectionReconfiguration message comprises at least one of: a dataset identifier, a model identifier for the second side of the first model, or assistance information.

7. The method of claim 5, wherein evaluating whether the first model supports the particular AI or ML feature comprises at least one of:
evaluating whether the first side of the first model has been trained with a dataset identifier included in the RRCConnectionReconfiguration message;
evaluating whether the first side of the first model has been trained with a model identifier for the second side of the first model included in the RRCConnectionReconfiguration message; or
evaluating whether the first side of the first model has been trained with a dataset identifier included in UE Assistance Information (UAI) received in the RRCConnectionReconfiguration message.

8. (canceled)

9. (canceled)

10. The method of claim 1, wherein the indication of whether the first model supports the particular AI or ML feature is transmitted via an RRCReconfigurationComplete message.

11. The method of claim 1, wherein evaluating, whether the first model supports the particular AI or ML feature further comprises at least one of the following:
evaluating UE, whether a current position of the UE supports the particular AI or ML feature;
evaluating whether a current measurement made at the UE supports the particular AI or ML feature; or
evaluating, whether a current value of assistance information supports the particular AI or ML feature.

12. (canceled)

13. The method of claim 1, further comprising:
receiving an activation command from the base station, wherein the activation command indicates to the wireless device to activate the first model with the particular AI or ML feature.

14. (canceled)

15. The method of claim 13, further comprising:
transmitting to the base station an indication of a desire to deactivate the first model; and
deactivating use of the first model.

16. The method of claim 15, wherein the indication of the desire to deactivate the first model is transmitted via UAI.

17. The method of claim 1, wherein the at least one task comprises a beam management (BM)-related task, wherein the indication of the particular AI or ML feature is received via an RRCConnectionReconfiguration message, and wherein the RRCConnectionReconfiguration message includes a spatial domain beam prediction message.

18. The method of claim 17, wherein the spatial domain beam prediction message comprises: a Set A and Set B mapping pattern.

19. The method of claim 1, wherein the at least one task comprises a positioning-related task, wherein the indication of the particular AI or ML feature is received via an RRCConnectionReconfiguration message, and wherein the RRCConnectionReconfiguration message includes site-specific scenario information.

20.-37. (canceled)

38. A wireless device comprising:
a receiver;
a transmitter;
at least one interface; and
a processor configured to cause the wireless device to:
receive a first capability inquiry from a base station, wherein the first capability inquiry relates to a capability of the UE to perform at least one task using a first model based on artificial intelligence (AI) or machine learning (ML);
transmit to the base station a response to the first capability inquiry, wherein the response indicates whether the UE can perform the at least one task;
receive an indication of a particular AI or ML feature;
evaluate whether the first model supports the particular AI or ML feature; and
transmit to the base station an indication of whether the first model supports the particular AI or ML feature.

39. The wireless device of claim 38, wherein a first task of the at least one task comprises a CSI compression task, and wherein the first model comprises a two-sided AI or ML model, a first side of the two-sided AI or ML model is implemented at the UE, and a second side of the two-sided AI or ML model is implemented at the base station.

40. The wireless device of claim 38, wherein the at least one task comprises a beam management (BM)-related task, wherein the indication of the particular AI or ML feature is received via an RRCConnectionReconfiguration message, and wherein the RRCConnectionReconfiguration message includes a spatial domain beam prediction message.

41. A baseband processor configured to cause a wireless device to:
receive a first capability inquiry from a base station, wherein the first capability inquiry relates to a capability of the UE to perform at least one task using a first model based on artificial intelligence (AI) or machine learning (ML);
transmit to the base station a response to the first capability inquiry, wherein the response indicates whether the UE can perform the at least one task;
receive an indication of a particular AI or ML feature;
evaluate whether the first model supports the particular AI or ML feature; and
transmit to the base station an indication of whether the first model supports the particular AI or ML feature.

42. The baseband processor of claim 41, wherein a first task of the at least one task comprises a CSI compression task, and wherein the first model comprises a two-sided AI or ML model, a first side of the two-sided AI or ML model is implemented at the UE, and a second side of the two-sided AI or ML model is implemented at the base station.

43. The baseband processor of claim 41, wherein the at least one task comprises a beam management (BM)-related task, wherein the indication of the particular AI or ML feature is received via an RRCConnectionReconfiguration message, and wherein the RRCConnectionReconfiguration message includes a spatial domain beam prediction message.
